(19) United States
(12) Patent Application Publication
(10) Pub. No.: US 2025/0303834 A1
(43) Pub. Date: Oct. 2, 2025

(54) VEHICLE SHADE APPARATUS

(71) Applicant: AISIN CORPORATION, Kariya-shi (JP)

(72) Inventors: Kazutoshi OTOKODANI, Kariya-shi (JP); Shota MOTOMURA, Kariya-shi (JP); Ryuto YANAGITANI, Kariya-shi (JP)

(73) Assignee: AISIN CORPORATION, Kariya-shi (JP)

(21) Appl. No.: 19/089,667

(22) Filed: Mar. 25, 2025

(30) Foreign Application Priority Data
Mar. 28, 2024 (JP) 2024-053853

(51) Int. Cl. B60J 7/00; B60J 7/06

(52) U.S. Cl. CPC B60J 7/0015; B60J 7/067

(57) ABSTRACT

A vehicle shade apparatus is provided on a roof of a vehicle. The vehicle shade apparatus includes: a shade; a winding member that winds the shade; a spool member attached to the winding member so as to rotate coaxially and integrally with the winding member; a string that has one end fixed to the spool member and is wound around the spool member; a drive device that pulls the string to rotate the spool member and the winding member in a winding direction of the shade; and a position adjustment mechanism that enables adjustment of a fixing position of the string in the spool member in a circumferential direction of the winding member.

### CROSS REFERENCE TO RELATED APPLICATIONS

This application is based on and claims priority under 35 U.S.C. § 119 to Japanese Patent Application No. 2024-053853, filed on Mar. 28, 2024, the entire content of which is incorporated herein by reference.

### TECHNICAL FIELD

This disclosure relates to a vehicle shade apparatus provided on a roof of a vehicle.

### BACKGROUND DISCUSSION

Conventionally, a drive device for a sun shade including a shade shaft, a sheet-like sun shade, first and second cable drums, a driving system cable, and a driven system cable is known (see, for example, Japanese Patent Application Laid-Open No. 2010-274693). In such a drive device, the shade shaft is rotatably disposed along one end edge of a roof window provided in a roof portion of the vehicle, and the sun shade is wound around the shade shaft in a roll shape so as to be drawn. The sun shade sets the roof window to a non-light shielding state when wound to a position of a winding end, and sets the roof window to a light shielding state when drawn to a position of the drawing end. Each of the first and second cable drums has a cable guide groove formed on each outer peripheral surface, and is integrally rotatably attached to a corresponding end of the shade shaft. One end of the driving system cable is connected to the first cable drum so as to be wound and drawn along the cable guide groove, and the other end of the driving system cable is connected to one end of a terminal bar attached to the drawing end of the sun shade. Furthermore, an intermediate portion of the driving system cable is connected to a drive drum that is rotationally driven in forward and reverse directions by using a motor as a drive source. One end of the driven system cable is connected to the second cable drum so as to be wound and drawn along the cable guide groove, and the other end of the driven system cable is connected to one end of the terminal bar. The drive device includes a tension spring that applies tension between the one end and the intermediate portion of the driving system cable, and a tension spring that applies tension between the other end and the intermediate portion of the driving system cable.

In a case where the sun shade wound around the shade shaft in a roll shape is drawn to set the roof window to the light shielding state, the drive drum is rotationally driven in a predetermined direction by the motor so as to wind the driving system cable and move in one direction. As a result, one end of the terminal bar is pulled by the driving system cable and moved toward the position of the drawing end, and the sun shade is drawn while the shade shaft is rotated in a drawing direction in accordance with the movement of the terminal bar. Furthermore, with the rotation of the shade shaft in the drawing direction, the first and second cable drums rotate in the same direction, and the driving system cable and the driven system cable are wound around the cable guide groove of the first or second cable drum. The cable guide grooves of the first and second cable drums are formed in a spiral shape that has a length corresponding to a drawn length of the sun shade and changes in accordance with a change in a winding diameter of the sun shade wound around the shade shaft. Therefore, the other end of the terminal bar is also pulled by the driven system cable and moved toward the position of the drawing end, and the terminal bar moves to the position of the drawing end while the sun shade is drawn so that the roof window is in the light shielding state. In a case where the sun shade is wound around the shade shaft in a roll shape to set the roof window to the non-light shielding state, the drive drum is rotationally driven in a direction opposite to the predetermined direction by the motor so as to move the driving system cable in another direction. Thus, the first cable drum connected to the driving system cable is reversed, and the shade shaft and the second cable drum rotate in the same direction as the first cable drum. As a result, the sun shade is wound around the shade shaft, and the roof window is in the light shielding state.

Here, individual differences may occur in a thickness of the sun shade as described above. The winding amount of the sun shade on the shade shaft changes in accordance with the thickness of the sun shade to cause a deviation between the winding amount of the driving system cable by the drive drum and the movement amount (unwinding amount) of the sun shade. If the winding amount of the driving system cable and the movement amount of the sun shade are deviated, the sun shade cannot be appropriately moved (opened and closed), or the driving force required for opening and closing the sun shade may increase.

A need thus exists for a vehicle shade apparatus which is not susceptible to the drawback mentioned above.

### SUMMARY

A vehicle shade apparatus is provided on a roof of a vehicle. The vehicle shade apparatus includes: a shade; a winding member that winds the shade; a spool member attached to the winding member so as to rotate coaxially and integrally with the winding member; a string that has one end fixed to the spool member and is wound around the spool member; a drive device that pulls the string to rotate the spool member and the winding member in a winding direction of the shade; and a position adjustment mechanism that enables adjustment of a fixing position of the string in the spool member in a circumferential direction of the winding member.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a main part of a vehicle including a vehicle shade apparatus of this disclosure;

FIG. 2 is a schematic configuration diagram of the vehicle shade apparatus of this disclosure;

FIG. 3 is a front view of first and second drum members included in the vehicle shade apparatus of this disclosure;

FIG. 4 is a plan view of a first slack absorbing mechanism included in the vehicle shade apparatus of this disclosure;

FIG. 5 is a plan view of a second slack absorbing mechanism included in the vehicle shade apparatus of this disclosure;

FIG. 6 is a partial sectional view of a third slack absorbing mechanism included in the vehicle shade apparatus of this disclosure;

FIG. 7 is a sectional view taken along line VII-VII in FIG. 6;

FIG. 8 is a schematic configuration diagram for describing an operation of the vehicle shade apparatus of this disclosure;

FIG. 9 is a schematic diagram for describing an operation of the vehicle shade apparatus of this disclosure; and

FIG. 10 is a schematic configuration diagram for describing the operation of the vehicle shade apparatus of this disclosure.

### DETAILED DESCRIPTION

Next, embodiments for carrying out the disclosure of this disclosure will be described with reference to the drawings.

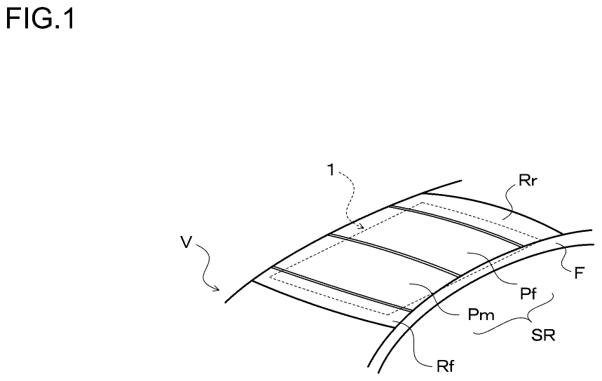

FIG. 1 is a perspective view showing a vehicle V including a vehicle shade apparatus (hereinafter, simply referred to as a “shade apparatus”) 1 of this disclosure. The vehicle V includes a sunroof device SR provided between a front roof panel Rf fixed to a vehicle body F and a rear roof panel Rr. The shade apparatus 1 is attached to the vehicle body F so as to be located below a transparent movable panel Pm and the transparent fixed panel Pf of the sunroof device SR. However, the shade apparatus 1 may be attached to the vehicle body F so as to be located below a fixed transparent roof (glass roof) provided between the front roof panel Rf and the rear roof panel Rr.

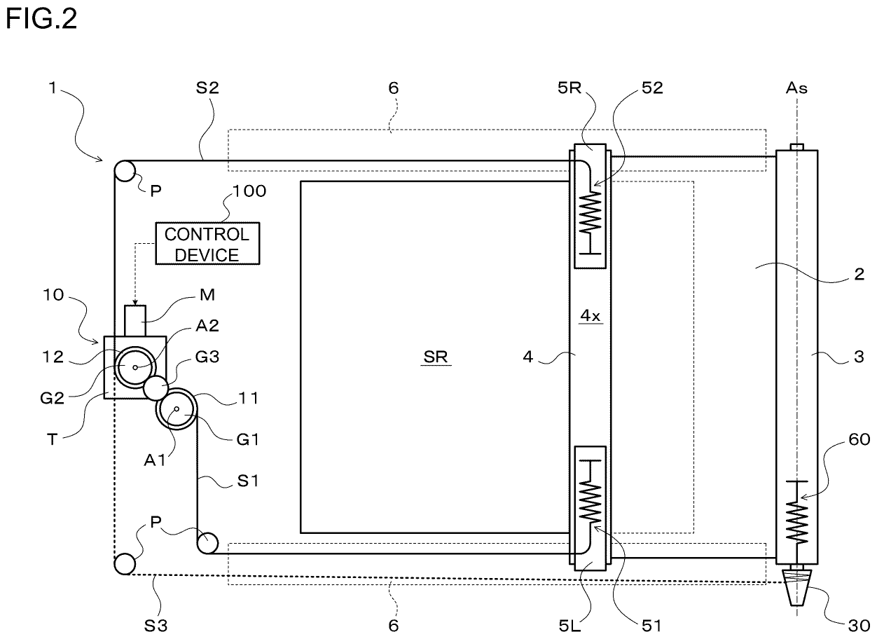

As shown in FIG. 2, the shade apparatus 1 includes a shade 2, a winding member 3, a shade bar 4, a pair (two) of shoes 5L and 5R, a pair (two) of guide members 6, and a rotary drive device 10 for opening and closing the shade 2. The shade 2 is, for example, a rectangular light shielding sheet including cloth, and has an area capable of completely covering a light transmitting portion of the movable panel Pm and the fixed panel Pf of the sunroof device SR. Note that the shade 2 may have heat shielding properties.

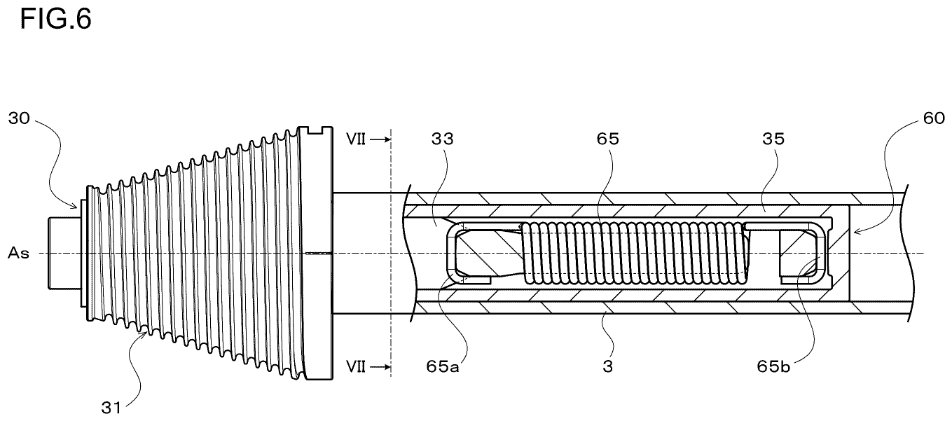

The winding member 3 is a cylindrical body having a relatively small outer diameter (for example, from about 10 mm to about 30 mm), and the shade 2a has a proximal end fixed (locked) to an outer peripheral surface of the winding member 3. One substantially conical (truncated conical) spool (spool member) 30 is coaxially attached to one axial end (in this embodiment, an end on a left side surface side of the vehicle V) of the winding member 3. In this embodiment, the spool 30 is attached to the winding member 3 such that a large diameter side (bottom surface side) is located on the winding member 3 side, and is rotatable coaxially and integrally with the winding member 3. Then, by rotating the winding member 3 and the spool 30 in a predetermined winding direction around an axis As (see FIG. 2) of the winding member 3 and the spool 30, the shade 2 can be wound around the winding member 3 and opened. A winding groove 31 (see FIG. 6) extending spirally around the axis As of the spool 30 is formed on an outer peripheral surface of the spool 30.

The shade bar 4 is formed in a hollow shape by extruding, for example, an aluminum alloy or the like. The shade bar 4 is fixed to a distal end of the shade 2 (an end opposite to the proximal end fixed to the winding member 3). In this embodiment, a tubular portion into which a rod material is inserted is formed at the distal end of the shade 2. The tubular portion and the rod material are fitted into a shade holding groove (not shown) formed in the shade bar 4, and the shade bar 4 is accordingly fixed to the distal end of the shade 2. In this embodiment, the shoes 5L and 5R include, for example, a resin containing potassium titanate fibers, and have a symmetrical structure. Each of the shoes 5L and 5R is inserted into an internal space 4x of the shade bar 4 from a corresponding end in a longitudinal direction of the shade bar 4, and is fixed to the shade bar 4.

Each guide member 6 is formed by extruding, for example, an aluminum alloy or the like, and has a uniform sectional shape in the longitudinal direction. Each guide member 6 slidably supports the corresponding shoe 5L or 5R and a corresponding side end of the shade 2. The pair of guide members 6 is fixed to a housing 7 accommodating the rotary drive device 10 and a support member (not shown) via a bolt or the like so as to extend in parallel to each other at an interval corresponding to a width of the shade 2. The housing 7 and the support member are fixed to the vehicle body F below the sunroof device SR such that the winding member 3 extends in a width direction of the vehicle V and the pair of guide members 6 extends in a front-rear direction of the vehicle V. In this embodiment, the housing 7 is located on a front side of the vehicle V, and the winding member 3 is located on a rear side of the vehicle V.

The rotary drive device 10 of the shade apparatus 1 pulls one first string S1 and one second string S2 to separate the shade bar 4, that is, the distal end of the shade 2, from the winding member 3, and pulls one third string S3 to rotate the winding member 3 about the axis As. As shown in FIG. 2, the rotary drive device 10 includes a first drum member 11, a second drum member 12, a single motor M as a rotary drive source, and a power transmission mechanism T.

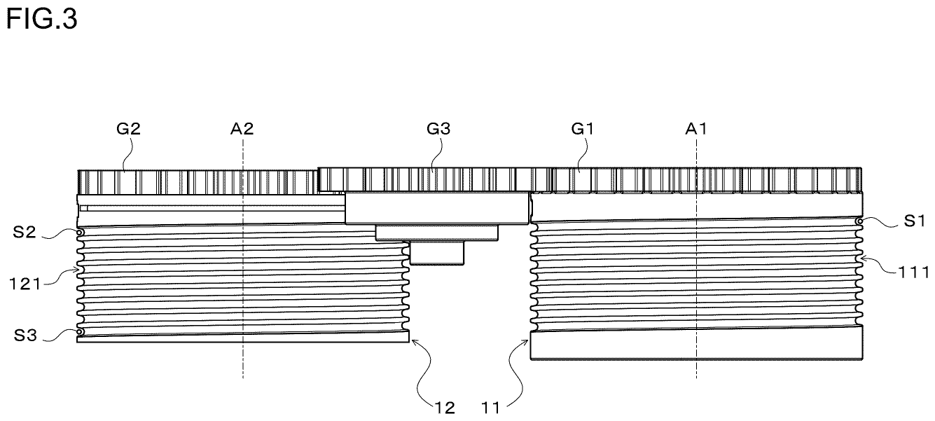

The first drum member 11 includes resin or the like so as to have a cylindrical outer peripheral surface, and is rotatable around the first axis A1. As shown in FIG. 3, a winding groove 111 extending spirally around the first axis A1 is formed on the outer peripheral surface of the first drum member 11. Furthermore, the first drum member 11 includes a first gear G1 that is a spur gear or a helical gear that is rotatable coaxially and integrally with the first drum member 11. The first gear G1 may be formed integrally with the first drum member 11, and the first gear G1 formed separately from the first drum member 11 may be fixed to the first drum member 11.

The second drum member 12 includes resin or the like so as to have a cylindrical outer peripheral surface, and is rotatable around a second axis A2. As shown in FIG. 3, a winding groove 121 extending spirally around the second axis A2 is formed on the outer peripheral surface of the second drum member 12. Furthermore, the second drum member 12 includes a second gear G2 that is a spur gear or a helical gear that is rotatable coaxially and integrally with the second drum member 12. The second gear G2 may be formed integrally with the second drum member 12, and the second gear G2 formed separately from the second drum member 12 may be fixed to the second drum member 12. The first and second drum members 11 and 12 are disposed side by side in a vehicle width direction of the vehicle V such that the first and second axes A1 and A2 are parallel to each other and extend in an up-down direction.

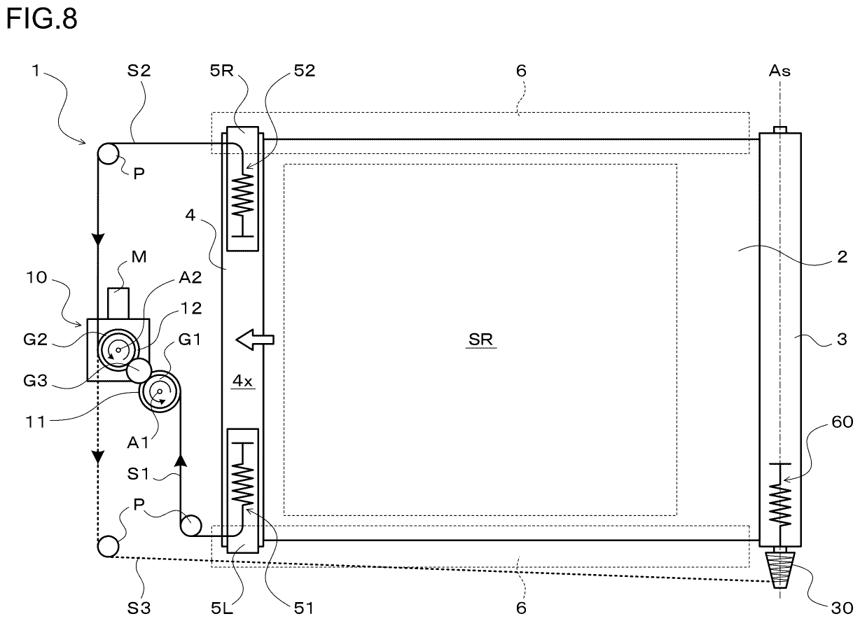

The first string S1 is a wire (metal wire) having an outer diameter of about 0.6 mm to about 1.5 mm, for example. However, the first string S1 may be a yarn or the like including chemical fibers or the like. A fixing piece (not shown) is attached to a proximal end of the first string S1, and the fixing piece is fitted into a fitted portion formed at an upper end (one end) of the outer peripheral surface of the first drum member 11. As a result, the proximal end of the first string S1 is fixed to the upper end of the outer peripheral surface of the first drum member 11. As can be seen from FIG. 3, when the first drum member 11 rotates in a predetermined first winding direction (see an arrow direction in FIG. 8) around the first axis A1, the first string S1 is wound around the winding groove 111 from an upper end side (one end side) toward a lower end side (the other end side) of the first drum member 11. The first string S1 protrudes from the winding groove 111 in a tangential direction with respect to the winding groove 111 and outward.

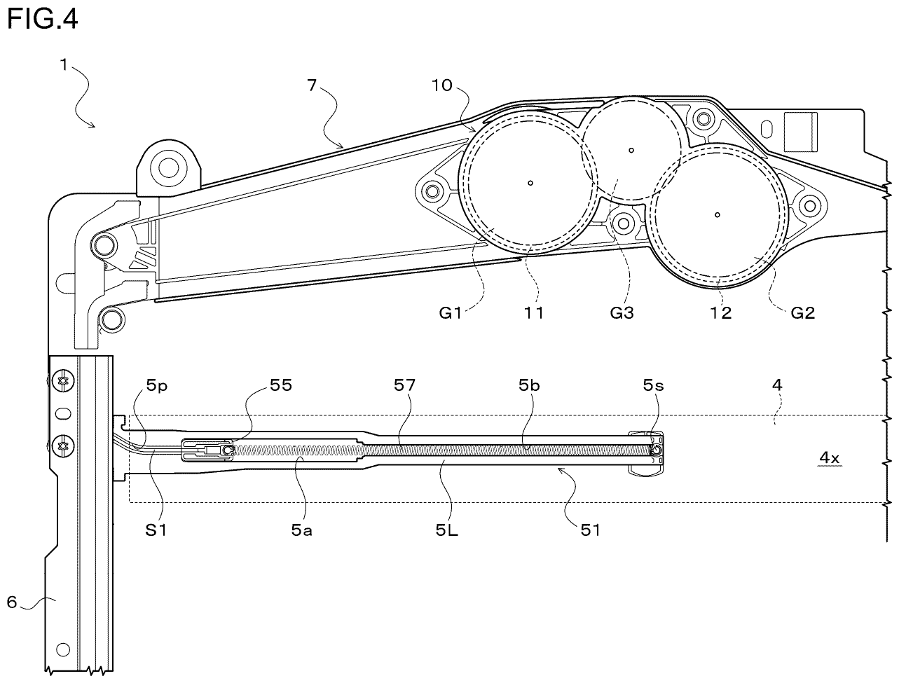

As shown in FIGS. 2 and 4, a distal end of the first string S1 is slidably inserted into one guide member 6, and slidably inserted into a string passage 5p (see FIG. 4) formed at an outer end of one shoe 5L fixed to the internal space 4x of the shade bar 4. Furthermore, the first string S1 is connected to the shade bar 4 via the first slack absorbing mechanism 51. As a result, the first string S1 is connected to one end side (left end side in FIG. 4) in the vehicle width direction of the shade bar 4 (the distal end of the shade 2) via the string passage 5p of the shoe 5L. The first slack absorbing mechanism 51 can absorb a slack of the first string S1, and includes the shoe 5L as a guide member, a slider 55, and a spring 57 as a biasing member.

As shown in FIG. 4, the shoe 5L includes a first guide space 5a, a second guide space 5b, and a spring support 5s in addition to the string passage 5p. The first guide space 5a communicates with the string passage 5p and extends in the longitudinal direction on one end side (left end side in FIG. 4) with respect to a central portion in the longitudinal direction of the shoe 5L. The second guide space 5b communicates with the first guide space 5a and extends in the longitudinal direction of the shoe 5L on the other end side (right end side in FIG. 4) of the shade bar 4 with respect to the first guide space 5a. The spring support 5s is formed at an inner end of the shoe 5L so as to be located on a side opposite to the string passage 5p side, that is, on a central portion side of the shade bar 4 and inside the second guide space 5b.

The slider 55 of the first slack absorbing mechanism 51 is a small piece including resin or the like, and is disposed in the first guide space 5a of the shoe 5L located on one end side of the shade bar 4 so as to be movable (slidable) in the longitudinal direction of the shade bar 4 (shoe 5L). The spring 57 of the first slack absorbing mechanism 51 is a tension coil spring and is disposed in the first and second guide spaces 5a and 5b. A proximal end (right end in FIG. 4) of the spring 57 is fixed to the spring support 5s in the second guide space 5b, and a distal end (left end in FIG. 4) of the spring 57 is fixed to one end (right end in FIG. 4) of the slider 55 in the first guide space 5a. As a result, the slider 55 is slidably disposed in the internal space 4x of the shade bar 4, and is biased by the spring 57 in a direction from one end (left end in FIG. 4) of the shade bar 4 toward the central portion (right direction in FIG. 4). The distal end of the first string S1 is fixed to the other end (left end in FIG. 4) of the slider 55 in the first guide space 5a of the shoe 5L, and is thus connected to the shade bar 4.

The second string S2 is also a wire (metal wire) having an outer diameter of about 0.6 mm to about 1.5 mm, for example. However, the second string S2 may be a yarn or the like including chemical fibers or the like. A fixing piece (not shown) is attached to a proximal end of the second string S2, and the fixing piece is fitted into a fitted portion formed at an upper end (one end) of the outer peripheral surface of the second drum member 12. As a result, the proximal end of the second string S2 is fixed to the upper end of the outer peripheral surface of the second drum member 12. As can be seen from FIG. 3, when the second drum member 12 rotates in a predetermined second winding direction (see an arrow direction in FIG. 8) around the second axis A2, the second string S2 is wound around the winding groove 121 from an upper end side (one end side) toward a lower end side (the other end side) of the second drum member 12. The second string S2 protrudes from the winding groove 121 in a tangential direction with respect to the winding groove 121 and outward.

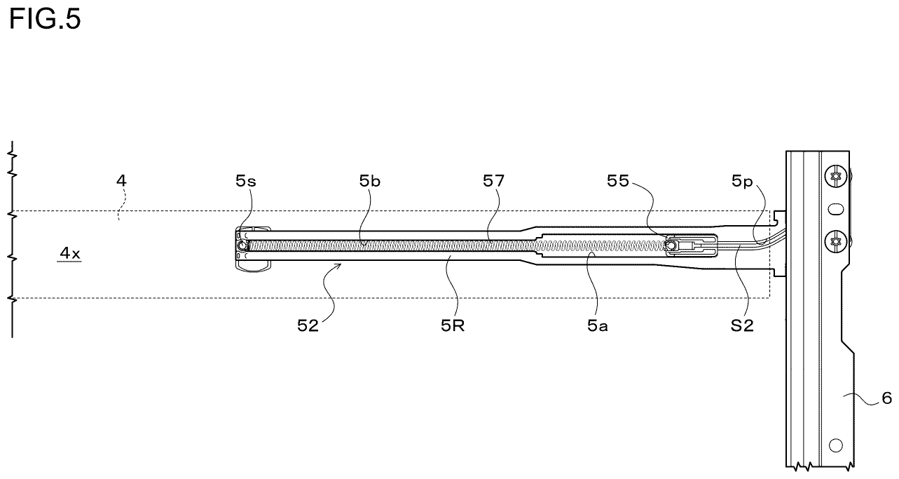

As shown in FIGS. 2 and 5, a distal end of the second string S2 is slidably inserted into the other guide member 6, and slidably inserted into the string passage 5p formed at an outer end of the other shoe 5R fixed to the internal space 4x of the shade bar 4. Furthermore, the second string S2 is connected to the shade bar 4 via the second slack absorbing mechanism 52. As a result, the second string S2 is connected to the other end side (right end side in FIG. 5) in the vehicle width direction of the shade bar 4 (the distal end of the shade 2) via the string passage 5p of the shoe 5R. The second slack absorbing mechanism 52 can absorb a slack of the second string S2, and includes the shoe 5R as a guide member, the slider 55, and the spring 57 as a biasing member, similarly to the first slack absorbing mechanism 51.

The shoe 5R includes a first guide space 5a, a second guide space 5b, and a spring support 5s in addition to the string passage 5p. The first guide space 5a of the shoe 5R communicates with the string passage 5p and extends in the longitudinal direction on the other end side (right end side in FIG. 5) with respect to a central portion in the longitudinal direction of the shoe 5R. The second guide space 5b communicates with the first guide space 5a and extends in the longitudinal direction of the shoe 5R on one end side (left end side in FIG. 5) of the shade bar 4 with respect to the first guide space 5a. The spring support 5s is formed at an inner end of the shoe 5R so as to be located on a side opposite to the string passage 5p side, that is, on a central portion side of the shade bar 4 and inside the second guide space 5b.

The slider 55 of the second slack absorbing mechanism 52 is also a small piece including resin or the like, and is disposed in the first guide space 5a of the shoe 5R located on the other end side of the shade bar 4 so as to be movable (slidable) in the longitudinal direction of the shade bar 4 (shoe 5R). The spring 57 of the second slack absorbing mechanism 52 is also a tension coil spring and is disposed in the first and second guide spaces 5a and 5b. A proximal end (left end in FIG. 5) of the spring 57 is fixed to the spring support 5 s in the second guide space 5b, and a distal end (right end in FIG. 5) of the spring 57 is fixed to one end (left end in FIG. 5) of the slider 55 in the first guide space 5a. As a result, the slider 55 of the second slack absorbing mechanism 52 is slidably disposed in the internal space 4x of the shade bar 4, and is biased by the spring 57 in a direction from the other end (right end in FIG. 5) of the shade bar 4 toward the central portion (left direction in FIG. 5). The distal end of the second string S2 is fixed to the other end (left end in FIG. 5) of the slider 55 in the first guide space 5a of the shoe 5R, and is thus connected to the shade bar 4.

The third string S3 is also a wire (metal wire) having an outer diameter of about 0.6 mm to about 1.5 mm, for example. However, the third string S3 may be a yarn or the like including chemical fibers or the like. A fixing piece (not shown) is attached to a proximal end of the third string S3, and the fixing piece is fitted into a fitted portion formed at a lower end (the other end) of the outer peripheral surface of the second drum member 12. As a result, the proximal end of the third string S3 is fixed to the lower end of the outer peripheral surface of the second drum member 12.

As can be seen from FIGS. 2 and 3, when the second drum member 12 rotates in a direction opposite to the second winding direction around the second axis A2, the third string S3 is wound around the winding groove 121 from a lower end side (the other end side) toward an upper end side (one end side) of the second drum member 12. The third string S3 protrudes from the winding groove 121 in a tangential direction with respect to the winding groove 121 and to a side opposite to the second string S2. The distal end of the third string S3 is fixed (locked) to an end on the large diameter side of the spool 30 fixed to the winding member 3, and the third string S3 is wound around the winding groove 31 of the spool 30 in a direction opposite to the winding direction of the shade 2.

As shown in FIG. 6, a third slack absorbing mechanism 60 that absorbs a slack of the third string S3 is disposed inside the winding member 3 which is a hollow cylindrical body. The third slack absorbing mechanism 60 includes a torsion spring 65 as a biasing member that biases the spool 30 in a direction opposite to the winding direction of the shade 2 so as to absorb the slack of the third string S3. Furthermore, the spool 30 includes a shaft 33 and an outer tubular member 35 as insertion portions constituting the third slack absorbing mechanism 60 together with the torsion spring 65. The shaft 33 extends in the axial direction from an end surface on the large diameter side of the spool 30 to a side opposite to an end on a small diameter side. The outer tubular member 35 is a substantially cylindrical tubular body that functions as a holder that rotatably supports the shaft 33, and is inserted into the winding member 3 and fixed so as to rotate integrally with the winding member 3.

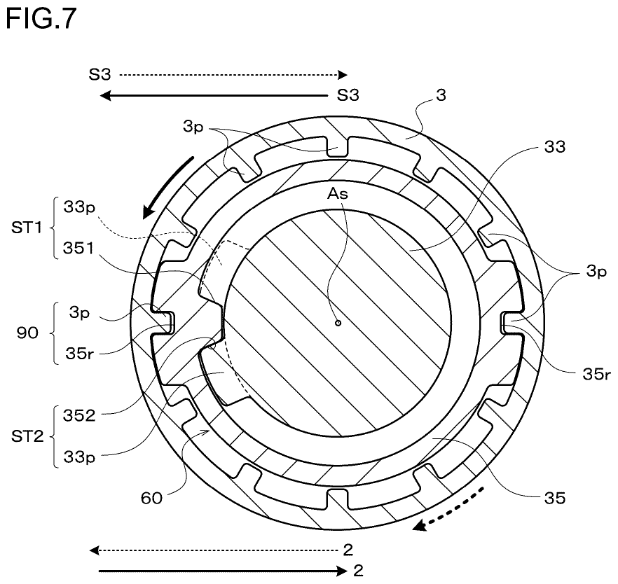

As shown in FIG. 7, a plurality of protrusions (ridges) 3p is formed on an inner peripheral surface of the winding member 3 at intervals (at equal intervals) in a circumferential direction. In this embodiment, for example, twelve protrusions 3p are formed on the inner peripheral surface of the winding member 3 at intervals of, for example, 30°, and each protrusion 3p protrudes from the inner peripheral surface of the winding member 3 toward the axis As and extends in parallel to the axis As over the entire length of the winding member 3. As shown in FIG. 7, in the outer tubular member 35 forming the insertion portion of the spool 30, a pair of recesses 35r is formed at an interval of 180° so as to be fitted to any of the plurality of protrusions 3p of the winding member 3. Each recess 35r is defined between two protrusions protruding radially outward from an outer peripheral surface of the outer tubular member 35, and extends in an axial direction over the entire length of the outer tubular member 35. That is, the outer tubular member 35 of the spool 30 is fixed to the winding member 3 so as to rotate integrally with the winding member 3 as the protrusion 3p of the winding member 3 is fitted to each of the pair of recesses 35r, and thus, the spool 30 is attached to the winding member 3. Then, the plurality of protrusions 3p of the winding member 3 and the pair (plurality) of recesses 35r of the outer tubular member 35 form a position adjustment mechanism 90 that enables adjustment of a fixing position of the third string S3 in the spool 30 in the circumferential direction of the winding member 3.

The torsion spring 65 of the third slack absorbing mechanism 60 is a so-called torsion coil spring, and is disposed in the outer tubular member 35 so as to extend coaxially with the axis As. One end (left end in FIG. 6) 65a of the torsion spring 65 is held by the shaft 33 of the spool 30 so as not to be rotatable about the axis As with respect to the spool 30. The other end (right end in FIG. 6) 65b of the torsion spring 65 is held by the outer tubular member 35 so as not to be rotatable about the axis As with respect to the outer tubular member 35, that is, the winding member 3. The torsion spring 65 is held by the shaft 33 of the spool 30 and the outer tubular member 35 in a state of being twisted in the winding direction of the shade 2 around the axis As in advance so as to bias the spool 30 against the outer tubular member 35 in a direction (clockwise direction in FIG. 7) opposite to the winding direction (counterclockwise direction in FIG. 7) of the shade 2 about the winding member 3.

Furthermore, the third slack absorbing mechanism 60 includes a first stopper ST1 and a second stopper ST2. As shown in FIG. 7, the first stopper ST1 includes a projection 33p protruding radially outward from the outer peripheral surface of the shaft 33 of the spool 30, and a first abutting surface 351 formed on the outer tubular member 35. In this embodiment, a first end surface of the projection 33p on a downstream side in the winding direction of the shade 2 and the first abutting surface 351 extend in the radial direction and the axial direction of the shaft 33. When the first end surface of the projection 33p abuts on the first abutting surface 351 of the outer tubular member 35, the rotation of the spool 30 in the winding direction about the winding member 3 of the shade 2 is restricted.

As shown in FIG. 7, the second stopper ST2 includes the projection 33p of the shaft 33 and a second abutting surface 351 formed on the outer tubular member 35 so as to be separated from the first abutting surface 352 in a direction opposite to the winding direction of the shade 2 and in the circumferential direction. In this embodiment, a second end surface of the projection 33p on an upstream side in the winding direction of the shade 2 and the second abutting surface 352 extend in the radial direction and the axial direction of the shaft 33. When the second end surface of the projection 33p abuts on the second abutting surface 352 of the outer tubular member 35, the rotation of the spool 30 in a direction opposite to the winding direction of the shade 2 about the winding member 3 is restricted.

When the shaft 33 of the spool 30, the outer tubular member 35, and the torsion spring 65 are assembled to the winding member 3, the spool 30 is biased by the torsion spring 65 in a direction (clockwise direction in FIG. 7) opposite to the winding direction of the shade 2, and thus, the second end surface of the projection 33p abuts on the second abutting surface 352 of the outer tubular member 35. When the third string S3 fixed to the spool 30 is wound and pulled by the second drum member 12, the first end surface of the projection 33p of the spool 30 (shaft 33) abuts on the first abutting surface 351 of the outer tubular member 35. In this embodiment, a spring constant (rigidity) of the torsion spring 65 is determined such that when the rotation of the second drum member 12 and the spool 30 is stopped and no slack is generated in the third string S3 between the second drum member 12 and the spool 30, a tension of the third string S3 becomes slightly larger than a biasing force of the torsion spring 65, and the first end surface of the projection 33p and the first abutting surface 351 of the outer tubular member 35 are maintained abutting on each other.

As shown in FIG. 2, the rotary drive device 10 includes a third gear (idler gear) G3 that meshes with the first gear G1 of the first drum member 11 and the second gear G2 of the second drum member 12. The motor M of the rotary drive device 10 rotates the second drum member 12 in forward and reverse directions about the second axis A2 via the power transmission mechanism T. As a result, the first drum member 11 rotates in the same direction as the second drum member 12 in synchronization with the rotation of the second drum member 12. In this embodiment, the first winding direction of the first drum member 11 and the second winding direction of the second drum member 12 are the same direction. As a result, by rotating the motor M in a predetermined first direction, the first drum member 11 can be rotated in the first winding direction to wind the first string S1 around the winding groove 111 of the first drum member 11, and the second drum member 12 can be rotated in the second winding direction to wind the second string S2 around the winding groove 121 of the second drum member 12.

In the shade apparatus 1, the specifications of the first drum member 11 including the winding groove 111 and the second drum member 12 including the winding groove 121 are determined such that a winding amount of the first string S1 by the first drum member 11 and a winding amount of the second string S2 by the second drum member 12 are the same when the motor M rotates by a predetermined angle in the first direction, and an unwinding amount of the first string S1 by the first drum member 11 and an unwinding amount of the second string S2 by the second drum member 12 are the same when the motor M rotates by a predetermined angle in a second direction opposite to the first direction. Furthermore, in the shade apparatus 1, the specifications of the second drum member 12 including the winding groove 121 are determined such that the winding amount of the second string S2 by the second drum member 12 and an unwinding amount of the third string S3 are the same when the motor M rotates by a predetermined angle in the first direction, and the unwinding amount of the second string S2 by the second drum member 12 and a winding amount of the third string S3 are the same when the motor M rotates by a predetermined angle in the second direction.

In this embodiment, the motor M is, for example, a DC motor with brushes, and is controlled by a control device 100 (see FIG. 2). The control device 100 includes a microcomputer including a CPU, a ROM, a RAM, an input/output interface, and the like, and controls the motor M in response to an operation of a shade opening/closing switch (not shown) by a user. The power transmission mechanism T includes, for example, a speed reducer, a gear mechanism, and the like. Furthermore, the shade apparatus 1 includes a plurality of pulleys P (see FIG. 2) rotatably supported by the housing 7 or the like so as to restrict the paths of the corresponding first, second, or third strings S1, S2, and S3.

Next, the operation of the shade apparatus 1 described above will be described with reference to FIGS. 8 to 10.

When the user instructs closure (full closure or semi closure) of the shade 2 via the shade opening/closing switch in a state where the shade 2 is wound around the winding member 3 and at least partially opened, the control device 100 controls the motor M of the rotary drive device 10 to rotate the second drum member 12 in the second winding direction (counterclockwise direction in FIG. 8) as shown in FIG. 8. When the second drum member 12 rotates in the second winding direction, the first drum member 11 rotates in the first winding direction (counterclockwise direction in FIG. 8) in synchronization with the rotation of the second drum member 12.

When the first and second drum members 11 and 12 are rotated in the first or second winding direction by the motor M of the rotary drive device 10, the first string S1 is wound around the first drum member 11, and the second string S2 is wound around the second drum member 12. Accordingly, the shade bar 4, that is, the distal end of the shade 2 is pulled toward the first and second drum members 11 and 12 side so as to be separated from the winding member 3 by the first and second strings S1 and S2. As a result, the shade 2 can be drawn from the winding member 3 and fully closed or semi-closed.

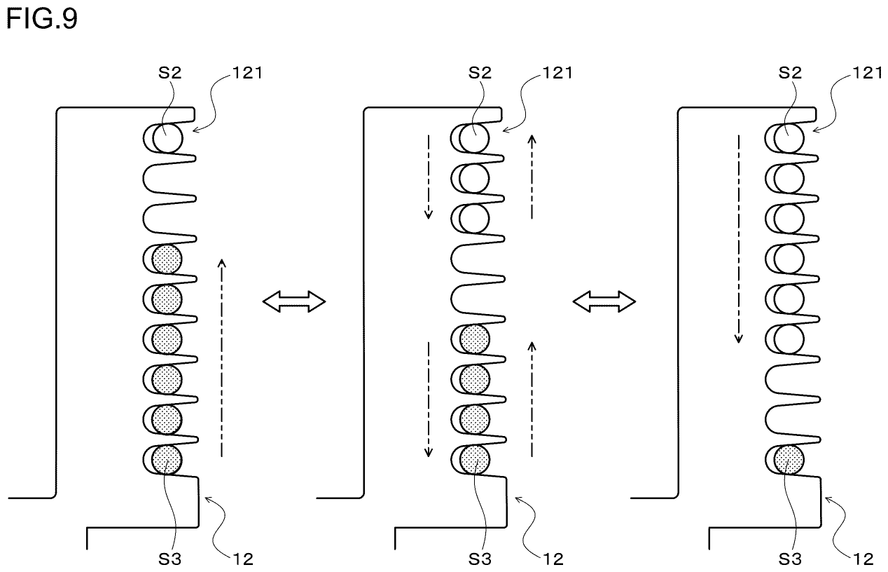

In response to the drawing of the shade 2, the winding member 3 rotates in a direction opposite to the winding direction of the shade 2. Furthermore, as indicated by an alternate long and short dash line in FIG. 9, the rotary drive device 10 rotates the second drum member 12 in the second winding direction, and winds the second string S2 around the empty winding groove 121 from the upper end side toward the lower end side of the second drum member 12 while unwinding the third string S3 from the winding groove 121. As a result, the winding member 3 is rotated in the direction opposite to the winding direction of the shade 2 in response to the drawing of the shade 2, and the third string S3 unwound from the second drum member 12 can be wound around the spool 30 rotating together with the winding member 3.

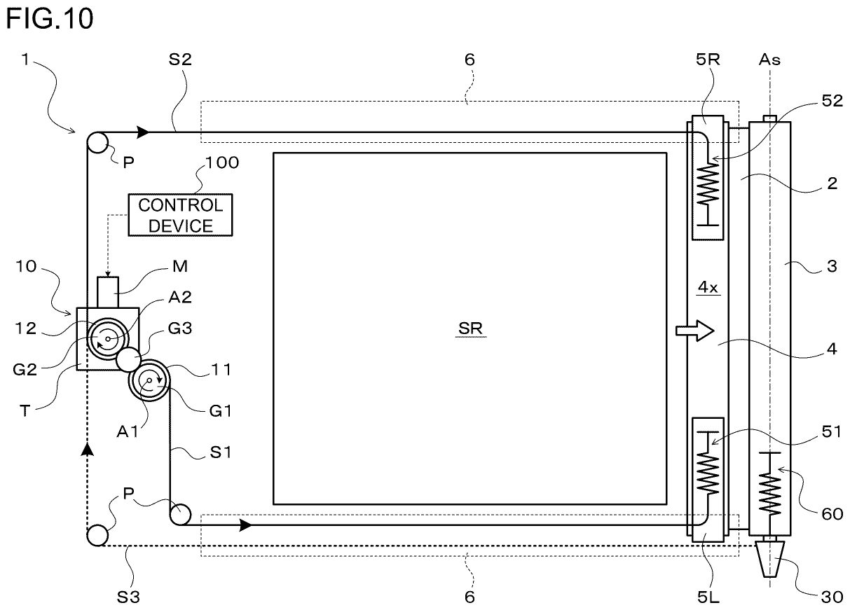

On the other hand, when the user instructs to open (fully open or half-open) the shade 2 via the shade opening/closing switch in a state where the shade 2 is drawn from the winding member 3 and is at least partially closed, the control device 100 controls the motor M of the rotary drive device 10 to rotate the second drum member 12 in a direction opposite to the second winding direction (clockwise direction in FIG. 10) as shown in FIG. 10. When the second drum member 12 rotates in a direction opposite to the second winding direction, the first drum member 11 rotates in a direction opposite to the first winding direction (clockwise direction in FIG. 10) in synchronization with the rotation of the second drum member 12.

When the first and second drum members 11 and 12 are rotated in the direction opposite to the first winding direction or the direction opposite to the second winding direction by the motor M of the rotary drive device 10, the first string S1 is unwound from the first drum member 11, the second string S2 is unwound from the second drum member 12, and furthermore, the third string S3 is wound around the second drum member 12. Thus, the unwinding of the first and second strings S1 and S2 allows movement of the shade bar 4, that is, the distal end of the shade 2 toward the winding member 3 side, the spool 30 and the winding member 3 are rotated in the winding direction of the shade 2 by the winding (pulling) of the third string S3, and the shade 2 can be wound around and opened by the winding member 3. As a result, the shade 2 can be wound around the winding member 3 to be fully opened or half-opened.

As described above, in the shade apparatus 1, the first string S1 is wound around the first drum member 11, and the second string S2 is wound around the second drum member 12 separate from the first drum member 11. Therefore, the winding amount of the first string S1 by the first drum member 11 and the winding amount of the second string S2 by the second drum member 12 can be easily matched, and the unwinding amount of the first string S1 by the first drum member 11 and the unwinding amount of the second string S2 by the second drum member 12 can be easily matched. The second drum member 12 unwinds the third string S3 when winding the second string S2, and winds the third string S3 when unwinding the second string S2. Therefore, the winding amount of the second string S2 by the second drum member 12 and the unwinding amount of the third string S3 can be easily matched, and the unwinding amount of the second string S2 by the second drum member 12 and the winding amount of the third string S3 can be easily matched.

As a result, the shade bar 4, that is, the distal end of the shade 2 can be suppressed from moving in an inclined state with respect to the winding member 3, and the shade 2 can be appropriately moved (opened and closed). Furthermore, when the second drum member 12 is rotated, it is possible to wind one of the second string S2 or the third string S3 while unwinding the other without interfering the second string S2 and the third string S3 with each other. As a result, an increase in an axial length of the second drum member 12 can be suppressed. Therefore, in the shade apparatus 1, it is possible to suppress an increase in size of the entire apparatus and to appropriately move the shade 2.

Each of the first and second drum members 11 and 12 has the winding groove 111 or 121 formed on the outer peripheral surface so as to extend spirally around the first or second axis A1 or A2. Then, the second string S2 is wound around the winding groove 121 from the upper end side (one end side) toward the lower end side (the other end side) of the second drum member 12 in the axial direction, and the third string S3 is wound around the winding groove 121 from the lower end side (the other end side) toward the upper end side (one end side) of the second drum member 12. Thus, when the second drum member 12 is rotated, it is possible to wind one of the second string S2 or the third string S3 around the empty winding groove 121 while unwinding the other from the winding groove 121 without interfering the second and third strings S2 and S3 with each other. As a result, an increase in the axial length of the second drum member 12 can be suppressed significantly well.

Furthermore, in the shade apparatus 1, a biasing mechanism (retractor) that biases the shade 2 in the winding direction can be omitted from the winding member 3, and the winding member 3 can be reduced in diameter. By adopting a configuration in which the third string S3 is wound around the second drum member 12 to open the shade 2, a movable range of the shade 2 is not limited due to the restriction of the biasing mechanism. Furthermore, the omission of the biasing mechanism enables a weight reduction and cost reduction of the entire apparatus. Since the structure for restricting the paths of the first, second, and third strings S1, S2, and S3 can be reduced in height and simplified as compared with a geared cable or the like, the entire apparatus can be made compact. Furthermore, since a loss associated with the driving of the first, second, and third strings S1, S2, and S3 is also reduced as compared with a geared cable or the like, an increase in size of the rotary drive device 10 can be suppressed.

In the shade apparatus 1, the first and second drum members 11 and 12 are disposed side by side in the width direction of the vehicle V. It is therefore possible to suppress an increase in dimension in a height direction of the shade apparatus 1 and a drawing direction of the shade 2 (the front-rear direction of the vehicle V), and to satisfactorily ensure mountability of the shade apparatus 1.

Furthermore, in the shade apparatus 1, the first winding direction of the first drum member 11 and the second winding direction of the second drum member 12 are the same direction, and the rotary drive device 10 includes the first gear G1 that is rotatable coaxially and integrally with the first drum member 11, the second gear G2 that is rotatable coaxially and integrally with the second drum member 12, the third gear G3 that meshes with the first and second gears G1 and G2, and the single motor M that rotates the second drum member 12 in forward and reverse directions. As a result, the first and second drum members 11 and 12 can be rotated in the first or second winding direction by the single motor M, and the first and second drum members 11 and 12 can be rotated in the direction opposite to the first winding direction or the direction opposite to the second winding direction. By using one motor M, the number of components of the rotary drive device 10 can be decreased to reduce the cost, and the rotary drive device 10 and the shade apparatus 1 can be reduced in size and weight. However, the rotary drive device 10 is not limited to a device including the first, second, and third gears G1, G2, and G3 and the single motor M as long as the second drum member 12 is rotated in the second winding direction when the first drum member 11 is rotated in the first winding direction, and the second drum member 12 is rotated in the direction opposite to the second winding direction when the first drum member 11 is rotated in the direction opposite to the first winding direction.

In the shade apparatus 1, the shade bar 4 having the internal space 4x is fixed to the distal end of the shade 2. Furthermore, the first string S1 is inserted into the internal space 4x from one end of the shade bar 4, and is connected to the shade bar 4 via the first slack absorbing mechanism 51 that absorbs the slack of the first string S1. The second string S2 is inserted into the internal space 4x from the other end of the shade bar 4, and is connected to the shade bar 4 via the second slack absorbing mechanism 52 that absorbs the slack of the second string S2. Furthermore, the shade apparatus 1 includes the third slack absorbing mechanism 60 that is disposed inside the winding member 3 and biases the spool 30 in the direction opposite to the winding direction of the shade 2.

That is, the shade 2 and the first, second, and third strings S1, S2, and S3 expand due to a change in ambient temperature, application of a tensile load, and the like. When expansion occurs in at least any one of the shade 2, the first, second, or third string S1, S2, or S3, a correlation between a movement amount of the first, second, or third string S1, S2, or S3 (a drawing amount from the winding member 3) and a movement amount of the shade 2 is disordered, and slack occurs in at least any of the first, second, or third string S1, S2, or S3. When the slack of at least any of the first, second, or third string S1, S2, or S3 exceeds an allowable amount, the shade 2 cannot be appropriately moved by winding the first, second, and third strings S1, S2, and S3 around the first and second drum members 11 and 12, and in some cases, the first, second, or third string S1, S2, and S3 may be detached from the pulley P.

For example, when expansion occurs in the shade 2, even if the first and second strings S1 and S2 are wound around the first or second drum member 11 or 12 by a prescribed amount to close the shade 2, the shade 2 is drawn from the winding member 3 after the slack due to the expansion is eliminated. Therefore, the shade 2 is not drawn from the winding member 3 by an amount corresponding to the prescribed amount, and the rotation of the winding member 3 and the spool 30 becomes insufficient to cause slack in the first and second strings S1 and S2. When expansion occurs in the shade 2, even if the third string S3 is wound around the second drum member 12 by a prescribed amount to open the shade 2, the shade 2 is wound around the winding member 3 after the slack due to the expansion is eliminated. Therefore, the shade 2 is not wound by the winding member 3 by an amount corresponding to the prescribed amount, and slack occurs in the third string S3 due to an insufficient movement amount of the shade 2. Furthermore, when expansion occurs in at least any of the first, second, or third string S1, S2, or S3, the first string S1 or the like is slackened between the first drum member 11 and the shade bar 4 or the like.

On the basis of the above, in the shade apparatus 1, the first and second strings S1 and S2 are connected to the shade bar 4 via the first or second slack absorbing mechanism 51 or 52. In the shade apparatus 1, the third slack absorbing mechanism 60 is disposed inside the winding member 3. As a result, even if expansion occurs in at least any one of the shade 2, the first, second, or third string S1, S2, or S3, the occurrence of slack in at least any one of the first, second, or third string S1, S2, or S3 can be suppressed, and the shade 2 can be appropriately moved.

As described above, the first and second slack absorbing mechanisms 51 and 52 include the slider 55 that is slidably disposed in the internal space 4x of the shade bar 4 and to which the distal end of the first or second string S1 or S2 is fixed, and the spring 57 that biases the slider 55 in the direction from one end side or the other end side of the shade bar 4 toward the central portion of the shade bar 4. When no slack occurs in the first or second string S1 or S2 between the first drum member 11 or the second drum member 12 and the shade bar 4, the slider 55 of the first and second slack absorbing mechanisms 51 and 52 approaches one end or the other end of the shade bar 4 in the first guide space 5a of the shoe 5L or 5R against the biasing force of the spring 57 due to a tension from the first or second string S1 or S2 as shown in FIGS. 4 and 5.

On the other hand, when slack is about to occur in the first or second string S1 or S2 between the first or second drum member 11 or 12 and the shade bar 4, the slider 55 moves toward the central portion of the shade bar 4 by the biasing force of the spring 57 in accordance with the decrease in tension of the first or second string S1 or S2. Thus, the first or second string S1 or S2 are pulled in a direction from the first or second drum member 11 or 12 toward the shade bar 4 by the movement of the slider 55.

As a result, in the shade apparatus 1, occurrence of slack of the first and second strings S1 and S2 due to expansion of at least any one of the shade 2 or the first or second string S1 or S2 can be satisfactorily suppressed. The internal space 4x of the shade bar 4 is effectively used as an arrangement space of the first and second slack absorbing mechanisms 51 and 52, and it is possible to satisfactorily suppress an increase in size of the shade apparatus 1. Furthermore, the first and second slack absorbing mechanisms 51 and 52 include the shoe 5L or 5R as a guide member fixed to the internal space 4x of the shade bar 4. Each of the shoes 5L and 5R includes the spring support 5s that supports the proximal end of the spring 57 on the central portion side of the shade bar 4, and the first guide space (guide) 5a that slidably supports the slider 55 connected to the distal end of the spring 57 on one end side or the other end side of the shade bar 4. As a result, slidability of the slider 55 can be satisfactorily ensured, and occurrence of slack of the first and second strings S1 and S2 can be satisfactorily suppressed by the biasing force of the spring 57.

In the shade apparatus 1, when no slack occurs in the third string S3 between the second drum member 12 and the spool 30, the tension of the third string S3 overcomes the biasing force of the third slack absorbing mechanism 60, that is, the torsion spring 65, and the first end surface of the projection 33p of the spool 30 (shaft 33) abuts on the first abutting surface 351 of the outer tubular member 35. Thus, the rotation of the spool 30 in the winding direction of the shade 2 about the winding member 3 is restricted by the first stopper ST1. As a result, the shade 2 can be appropriately moved by winding the third string S3 around the second drum member 12 (see a solid arrow in FIG. 7) or unwinding the third string S3 from the second drum member 12 (see a dotted arrow in FIG. 7).

On the other hand, when slack is about to occur in the third string S3 between the second drum member 12 and the spool 30, the spool 30 is rotated in the direction opposite to the winding direction of the shade 2 by the biasing force (restoring force) of the torsion spring 65 until the tension of the third string S3 and the biasing force of the torsion spring 65 are balanced in accordance with the decrease in tension of the third string S3. Thus, the third string S3 is wound around the spool 30, and the slack of the third string S3 is absorbed by the third slack absorbing mechanism 60. As a result, in the shade apparatus 1, even if expansion occurs in at least any one of the shade 2 or the third string S3, it is possible to satisfactorily suppress the occurrence of slack of the third string S3 and appropriately move the shade 2.

Furthermore, in the shade apparatus 1, the third slack absorbing mechanism 60 is disposed inside the winding member 3 which is a cylindrical body. As a result, the inside of the winding member 3 can be effectively used as an arrangement space of the third slack absorbing mechanism 60, and an increase in size of the shade apparatus 1 can be satisfactorily suppressed.

The third slack absorbing mechanism 60 includes the first stopper ST1 that restricts the rotation of the spool 30 about the winding member 3 in the winding direction of the shade 2. Thus, when the shade 2 is wound around the winding member 3 and opened, even if a large tension is applied from the second drum member 12 to the third string S3 drawn from the spool 30 and wound around the winding groove 121, a rotation angle of the spool 30 in the winding direction of the shade 2 about the winding member 3, that is, a twist amount of the torsion spring 65 can be limited to a predetermined upper limit or less. As a result, the tension applied from the spool 30 to the third string S3 (the tension in the winding direction of the third string S3 around the spool 30) becomes excessively large, and deterioration in durability of the torsion spring 65 due to excessive twisting in the winding direction of the shade 2 can be satisfactorily suppressed.

Furthermore, the third slack absorbing mechanism 60 includes the outer tubular member 35 that is fixed to the winding member 3 via the position adjustment mechanism 90 so as to rotate integrally with the winding member 3 and rotatably supports the shaft 33 extending from the spool 30, and the torsion spring (biasing member) 65 held by the spool 30 (shaft 33) and the outer tubular member 35 so as to bias the spool 30 against the outer tubular member 35 in a direction opposite to the winding direction of the shade 2. As a result, the third slack absorbing mechanism 60 that biases the spool 30 in the direction opposite to the winding direction of the shade 2 can be disposed in the winding member 3 while suppressing an increase in the outer diameter and inner diameter of the winding member 3.

When the shade apparatus 1 is manufactured, the shade 2 is wound around the winding member 3 in a state of being pulled with a predetermined force (for example, about 100 N). Therefore, individual differences may occur in the thickness of the shade 2. The winding amount (winding number) of the shade 2 in the winding member 3 changes in accordance with a thickness of the shade 2 to cause a deviation between the winding amount (drawing amount) of the third string S3 by the rotary drive device 10 (second drum member 12), that is, the unwinding amount from the spool 30 and the movement amount (unwinding amount) of the shade 2. On the basis of the above, the shade apparatus 1 is provided with the position adjustment mechanism 90 that enables the fixing position of the third string S3 in the spool 30 to be adjusted in the circumferential direction of the winding member 3 when the spool 30 is attached to the winding member 3.

That is, in the position adjustment mechanism 90, when the spool 30 is attached to the winding member 3, the pair of recesses 35r of the outer tubular member 35 and the corresponding protrusion 3p of the winding member 3 can be fitted to each other after the spool 30 is rotated by a predetermined angle (for example, 30°) in the winding direction (counterclockwise direction in FIG. 7) or the drawing direction (clockwise direction in FIG. 7) of the shade 2 about the winding member 3. As a result, even if the winding amount of the shade 2 in the winding member 3 changes in accordance with the thickness of the shade 2, the fixing position of the string in the spool 30 is deviated (rotated) in the circumferential direction of the winding member 3, and the deviation between the movement amount of the third string S3 drawn from the spool 30 by the rotary drive device 10 and the movement amount of the shade 2 can be reduced.

Specifically, when the thickness of the shade 2 is large and the winding amount of the shade 2 around the winding member 3 is small, the fixing position of the third string S3 in the spool 30 can be deviated (rotated) in the winding direction of the shade 2 with respect to the winding member 3 so as to slacken the third string S3 toward the second drum member 12 side. When the thickness of the shade 2 is small and the winding amount of the shade 2 around the winding member 3 is large, the fixing position of the third string S3 in the spool 30 can be deviated (rotated) in the drawing direction of the shade 2 with respect to the winding member 3 so as to pull the third string S3 toward the spool 30 side. As a result, in the shade apparatus 1, regardless of the thickness of the shade 2, the shade 2 can be appropriately moved, and an increase in driving force required for opening and closing the shade 2 can be suppressed.

In the shade apparatus 1, the spool 30 includes the outer tubular member 35 forming the insertion portion to be inserted into the winding member 3 which is a cylindrical body, and the position adjustment mechanism 90 includes the plurality of protrusions 3p provided in the winding member 3 and at least one recess 35r provided in the outer tubular member 35 of the spool 30 so as to be fitted to any of the plurality of protrusions 3p. As a result, regardless of a rotational position (phase) of the winding member 3 around which the shade 2 is wound, the fixing position of the third string S3 in the spool 30 can be adjusted at a fine pitch in the circumferential direction of the winding member 3. However, the position adjustment mechanism 90 may include a plurality of recesses provided in the winding member 3 and at least one protrusion provided in the outer tubular member 35 of the spool 30 so as to be fitted to any of the plurality of recesses.

Furthermore, in the shade apparatus 1, the position adjustment mechanism 90 includes the plurality of protrusions 3p formed at intervals in the circumferential direction on the inner peripheral surface of the winding member 3, and the pair of recesses 35r formed at an interval of 180° in the outer tubular member 35 of the spool 30 so as to be fitted to any of the plurality of protrusions 3p. As a result, the fixing position of the third string S3 in the spool 30 can be adjusted at a fine pitch in the circumferential direction of the winding member 3, and twisting of the outer tubular member 35 of the spool 30 with respect to the winding member 3 due to the biasing force from the torsion spring 65 of the third slack absorbing mechanism 60 can be satisfactorily suppressed. However, the position adjustment mechanism 90 may include a pair of recesses formed at an interval of 180° in the winding member 3 and a plurality of protrusions provided on the outer tubular member 35 of the spool 30 so as to be fitted to the pair of recesses.

In the shade apparatus 1, the power transmission mechanism T may be omitted from the rotary drive device 10, and the motor M may be directly connected to the second drum member 12. The rotary drive device 10 may be configured such that the motor M rotationally drives the first drum member 11. Furthermore, the third string S3 may be wound around the first drum member 11. The spools (spool members) 30 may be coaxially fixed to both ends one by one in the axial direction of the winding member 3. In this case, the third string S3 fixed to one of the spools 30 may be wound around the second drum member 12, and a fourth string fixed to the other one of the spools 30 may be wound around the first drum member 11. Furthermore, the shade apparatus 1 is attached to the vehicle body F so as to be located below the sunroof device SR or the fixed transparent roof of the vehicle V. However, this configuration is not limited, and the shade apparatus 1 may be provided on a rear window or a side window of the vehicle V.

The disclosure of this disclosure is not limited to the above embodiment at all, and it goes without saying that various modifications can be made within the scope of the extension of this disclosure. Furthermore, the above embodiment is merely a specific form of the disclosure described in the summary of disclosure, and does not limit the elements of the disclosure described in the summary of disclosure.

The disclosure of this disclosure is applicable to a manufacturing industry and the like of a vehicle shade apparatus.

A vehicle shade apparatus is provided on a roof of a vehicle. The vehicle shade apparatus includes: a shade; a winding member that winds the shade; a spool member attached to the winding member so as to rotate coaxially and integrally with the winding member; a string that has one end fixed to the spool member and is wound around the spool member; a drive device that pulls the string to rotate the spool member and the winding member in a winding direction of the shade; and a position adjustment mechanism that enables adjustment of a fixing position of the string in the spool member in a circumferential direction of the winding member.

The vehicle shade apparatus of this disclosure includes the spool member attached to the winding member that winds the shade such that the spool member rotates coaxially and integrally with the winding member. One end of the string is fixed to the spool member, and the string is wound around the spool member. Then, by pulling the string by the drive device to rotate the spool member and the winding member in the winding direction of the shade, the shade can be wound around the winding member and opened. Here, individual differences may occur in a thickness of the shade. A winding amount of the shade in the winding member changes in accordance with the thickness of the shade to cause a deviation between a drawing amount of the string by the drive device (an unwinding amount from the spool member) and a movement amount of the shade (the unwinding amount from the winding member). On the basis of the above, the vehicle shade apparatus of this disclosure is provided with the position adjustment mechanism that enables the fixing position of the string in the spool member to be adjusted in the circumferential direction of the winding member. As a result, even if the winding amount of the shade in the winding member changes in accordance with the thickness of the shade, the fixing position of the string in the spool member is deviated (rotated) in the circumferential direction of the winding member, and the deviation between the movement amount of the string drawn from the spool member by the drive device and the movement amount of the shade can be reduced. As a result, in the vehicle shade apparatus of this disclosure, regardless of the thickness of the shade, the shade can be appropriately moved, and an increase in driving force required for opening and closing the shade can be suppressed.

In the vehicle shade apparatus, the winding member is a cylindrical body, the spool member includes an insertion portion to be inserted into the winding member, and the position adjustment mechanism includes a plurality of protrusions or recesses provided on one of the winding member or the insertion portion of the spool member, and at least one recess or protrusion provided on another one of the winding member or the insertion portion of the spool member so as to be fitted to any of the plurality of protrusions or recesses.

In the vehicle shade apparatus, the position adjustment mechanism includes a plurality of protrusions formed at intervals in the circumferential direction on an inner peripheral surface of the winding member, and a pair of recesses formed at an interval of 180° in the insertion portion of the spool member so as to be fitted to any of the plurality of protrusions.

The vehicle shade apparatus further includes a slack absorbing mechanism that is disposed inside the winding member and biases the spool member in a direction opposite to the winding direction of the shade.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle shade apparatus provided on a roof of a vehicle, the vehicle shade apparatus comprising:
a shade;
a winding member that winds the shade;
a spool member attached to the winding member so as to rotate coaxially and integrally with the winding member;
a string that has one end fixed to the spool member and is wound around the spool member;
a drive device that pulls the string to rotate the spool member and the winding member in a winding direction of the shade; and
a position adjustment mechanism that enables adjustment of a fixing position of the string in the spool member in a circumferential direction of the winding member.

2. The vehicle shade apparatus according to claim 1, wherein
the winding member is a cylindrical body,
the spool member includes an insertion portion to be inserted into the winding member, and
the position adjustment mechanism includes a plurality of protrusions or recesses provided on one of the winding member or the insertion portion of the spool member, and at least one recess or protrusion provided on another one of the winding member or the insertion portion of the spool member so as to be fitted to any of the plurality of protrusions or recesses.

3. The vehicle shade apparatus according to claim 2, wherein
the position adjustment mechanism includes a plurality of protrusions formed at intervals in the circumferential direction on an inner peripheral surface of the winding member, and a pair of recesses formed at an interval of 180° in the insertion portion of the spool member so as to be fitted to any of the plurality of protrusions.

4. The vehicle shade apparatus according to claim 2, further comprising
a slack absorbing mechanism that is disposed inside the winding member and biases the spool member in a direction opposite to the winding direction of the shade.

3. The vehicle shade apparatus according to claim 3, further comprising
a slack absorbing mechanism that is disposed inside the winding member and biases the spool member in a direction opposite to the winding direction of the shade.
